(19) United States
(12) Patent Application Publication
(10) Pub. No.: US 2026/0200699 A1
(43) Pub. Date: Jul. 16, 2026

(54) ELEVATOR CAR ROOF PROTECTION DEVICE, ELEVATOR CAR AND ELEVATOR SYSTEM

(71) Applicant: Otis Elevator Company, Farmington, CT (US)

(72) Inventors: Wen Liu, Tianjin (CN); Yingjie Li, Tianjin (CN); Yue Liu, Tianjin (CN); Zhe Zhang, Tianjin (CN)

(21) Appl. No.: 19/395,256

(22) Filed: Nov. 20, 2025

(30) Foreign Application Priority Data
Jan. 13, 2025 (CN) 202510051907.9

(51) Int. Cl. B66B 5/00; B66B 11/02

(52) U.S. Cl. CPC B66B 5/0081; B66B 11/0226

(57) ABSTRACT

An elevator car roof protection device, an elevator car, and an elevator. The elevator car roof protection device includes: a guardrail arranged on a roof of an elevator car and defining a protective area, the guardrail is configured to be movable in a vertical direction relative to the roof under power drive such that the guardrail is adjustable to have different heights corresponding to different states of an elevator system; a power portion arranged on the roof and configured to provide the power to the guardrail; and a control portion arranged on the roof, the control portion is electrically connected to the power portion and configured to control operation of the power portion.

### FOREIGN PRIORITY

This application claims priority to Chinese Patent Application No. 202510051907.9, filed Jan. 13, 2025, and all the benefits accruing therefrom under 35 U.S.C. § 119, the contents of which in its entirety are herein incorporated by reference.

### TECHNICAL FIELD OF INVENTION

The present disclosure relates to the technical field of elevators, and in particular, to an elevator car roof protection device, an elevator car, and an elevator system.

### BACKGROUND OF THE INVENTION

In the event of a malfunction or abnormality in an elevator system, it is usually necessary to immediately perform maintenance on the elevator equipment. In addition, elevator equipment is often debugged or regularly inspected to ensure the normal and safe operation of the system. During maintenance, workers usually need to enter the elevator car roof to carry out corresponding work. For the purpose of ensuring personal safety and avoiding injury accidents, etc., a guardrail is generally mounted on the elevator car roof. For example, currently, mechanical telescopic guardrail is commonly used to allow the workers to unfold them after reaching the car roof, thus providing a protective area for workers and achieving the purpose of safety protection.

### SUMMARY OF THE INVENTION

In view of the foregoing, the present disclosure provides an elevator car roof protection device, an elevator car, and an elevator system, so as to solve or at least alleviate one or more of the problems existing in the prior art and other aspects, or to provide alternative solutions for the prior art.

Firstly, according to one aspect of the present disclosure, an elevator car roof protection device is provided, comprising: a guardrail arranged on a roof of an elevator car and defining a protective area, wherein the guardrail is configured to be movable in a vertical direction relative to the roof under power drive such that the guardrail is adjustable to have different heights corresponding to different states of an elevator system; a power portion arranged on the roof and configured to provide the power to the guardrail; and a control portion arranged on the roof, wherein the control portion is electrically connected to the power portion and configured to control operation of the power portion.

In an elevator car roof protection device according to the present disclosure, optionally, the guardrail is configured to have a first height relative to the roof when the elevator system is in a normal operation state, and have a second height relative to the roof when the elevator system is in a maintenance state, the second height being greater than the first height.

In an elevator car roof protection device according to the present disclosure, optionally, the guardrail comprise a first guardrail and a second guardrail adjacent to each other, the first guardrail being detachably connected to the second guardrail.

In an elevator car roof protection device according to the present disclosure, optionally, the first guardrail and the second guardrail are detachably connected through a connecting assembly, the connecting assembly comprising: a first connecting member, mounted on one of the first guardrail and the second guardrail, and having a first mating portion and an operating portion; and a second connecting member, disposed on the other of the first guardrail and the second guardrail, and having a second mating portion; wherein the operating portion is configured to apply a preset force to the first mating portion to engage it with the second mating portion after the first connecting member and the second connecting member are mounted in place, such that the first guardrail and the second guardrail are detachably connected and move up and down together, and to make the first mating portion to disengage from the second mating portion when an acting force between the first guardrail and the second guardrail is greater than the preset force, such that the first guardrail is disconnected from the second guardrail.

In an elevator car roof protection device according to the present disclosure, optionally, the first connecting member has a receiving space, and the first mating portion is configured as a slider movably arranged within the receiving space and abutting against the operating portion, the slider being moved toward the second mating portion under the action of the preset force to engage with the second mating portion.

In an elevator car roof protection device according to the present disclosure, optionally, the slider has a first inclined surface, and the second mating portion has a second inclined surface matching the first inclined surface, the first inclined surface and the second inclined surface abutting against each other after the first connecting member and the second connecting member are mounted in place; and/or, the operating portion comprises a spring.

In an elevator car roof protection device according to the present disclosure, optionally, the guardrail comprises a first guardrail, a second guardrail and a third guardrail, the second guardrail and the third guardrail are respectively arranged on two sides of the first guardrail, and at least one of the second guardrail and the third guardrail is detachably connected to the first guardrail.

In an elevator car roof protection device according to the present disclosure, optionally, the elevator car roof protection device further comprises a base arranged on the roof, and guide portions mounted on the base and connected to the guardrail, at least one of guide portions being connected to the power portion and transmitting the power to the guardrail.

In an elevator car roof protection device according to the present disclosure, optionally, the guide portion has a limiting portion, and the elevator car roof protection device further comprises a limiting member configured to operably engage with the limiting portion such that the guardrail is fixed at a current height position.

In an elevator car roof protection device according to the present disclosure, optionally, the limiting portion is configured as a slot having one or more limiting positions, and the limiting member comprises a latch pin which, when engaged with the limiting portion at different limiting positions, causes the guardrail to be fixed at different height positions.

In an elevator car roof protection device according to the present disclosure, optionally, the elevator car roof protection device further comprises: a detection member configured to generate a working signal that is transmitted to the control portion for control to stop the power portion from outputting the power when the guardrail reaches a preset height in the vertical direction; and/or a box arranged on the roof, at least a part of the control portion being arranged in the box.

In an elevator car roof protection device according to the present disclosure, optionally, the detection member comprises a limit switch, and the guardrail is configured with a mating portion which triggers the limit switch to generate the working signal when the guardrail reaches the preset height.

In an elevator car roof protection device according to the present disclosure, optionally, the box is arranged in a position adjacent to a landing door of the elevator system.

In an elevator car roof protection device according to the present disclosure, optionally, the power portion comprises one or more electric devices, and the elevator car roof protection device comprises a base arranged on the roof, the electric device being mounted on the base and an output end of the electric device being connected to the guardrail.

In addition, according to another aspect of the present disclosure, an elevator car is provided, wherein the roof of the elevator car is provided with an elevator car roof protection device according to any of the above.

Furthermore, according to yet another aspect of the present disclosure, an elevator system is further provided, comprising: one or more elevator cars, configured to run within an elevator hoistway and an elevator car roof protection device according to any of the above, mounted on the roof of at least one of the elevator cars.

The elevator car roof protection device of the present disclosure is easy to install and convenient to operate, which can effectively enhance safety protection, eliminate potential safety hazards, and prevent safety accidents caused by negligence by the workers to raise the guardrail height during maintenance and other situations, thereby helping to ensure the safety of on-site personnel and improve the safety performance of an elevator system. The elevator car roof protection device is widely applicable to many places such as public elevators, home lifts, etc., and has significant practicality.

### BRIEF DESCRIPTION OF THE DRAWINGS

The technical solutions of the present disclosure will be described in further detail below with reference to the accompanying drawings and embodiments. However, it should be understood that these drawings are designed merely for the purpose of explanation and only intended to conceptually illustrate the structures and configurations described herein, and are not required to be drawn to scale.

FIG. 1 is a three-dimensional structural schematic diagram of an example of an elevator system in which an embodiment of an elevator car roof protection device according to the present disclosure can be adopted.

FIG. 2 is a three-dimensional structural schematic diagram when an embodiment of an elevator car roof protection device according to the present disclosure is mounted on the roof of an elevator car, corresponding to the normal operation state of the elevator system at this point.

FIG. 3 is a three-dimensional structural schematic diagram after the height of the guardrail in the embodiment of the elevator car roof protection device shown in FIG. 2 is raised, corresponding to the maintenance state of the elevator system at this point.

FIG. 4 is a front-view structural schematic diagram of the rear-side guardrail, base, etc. in the embodiment of the elevator car roof protection device shown in FIG. 3.

FIG. 5 is a three-dimensional structural schematic diagram of the left-side guardrail, base, etc. in the embodiment of the elevator car roof protection device shown in FIG. 3.

FIGS. 6 and 7 are respectively three-dimensional structural schematic diagrams of the first connecting member and the second connecting member of the connecting assembly in the embodiment of the elevator car roof protection device shown in FIG. 3.

FIG. 8 is a three-dimensional structural schematic diagram of the power portion in the embodiment of the elevator car roof protection device shown in FIG. 3.

FIG. 9 is a three-dimensional structural schematic diagram of the guide portion in the embodiment of the elevator car roof protection device shown in FIG. 3.

FIG. 10 is a three-dimensional structural schematic diagram of the limiting member in the embodiment of the elevator car roof protection device shown in FIG. 3.

### DETAILED DESCRIPTION OF THE INVENTION

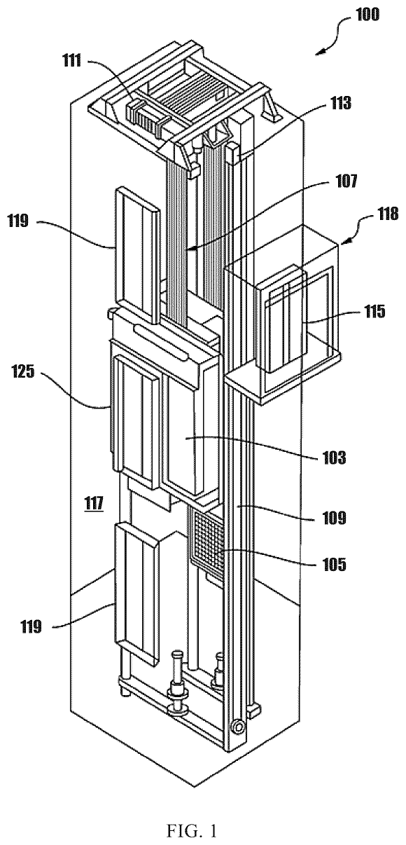

FIG. 1 is a perspective view of an elevator system 100 including an elevator car 103, a counterweight 105, a tension member 107, a guide rail (or rail system) 109, a machine (or machine system) 111, a position reference device 113, and an electronic elevator controller (controller) 115. The elevator car 103 and counterweight 105 are connected to each other by the tension member 107, and travel along an elevator hoistway 117 under the action of driving force. The tension member 107 may include, for example, steel belts (such as coated-steel belts) and/or ropes (such as steel cables). The counterweight 105 is configured to balance a load of the elevator car 103 and is configured to facilitate movement of the elevator car 103 concurrently and in an opposite direction with respect to the counterweight 105 within the elevator hoistway 117 and along the guide rail 109.

The tension member 107 engages the machine 111. The machine 111 is configured to control movement between the elevator car 103 and the counterweight 105. Machine 111 may include a motor or similar power unit to provide driving force to elevator system 100, which may adopt a machine-room-less configuration. The position reference device 113 may be arranged in other positions and/or configurations known in the art, such as being mounted on a fixed part at the top of the elevator hoistway 117. The position reference device 113 may be configured to provide position signals related to a position of the elevator car and/or counterweight within the elevator hoistway. The position reference device 113 can employ any device or mechanism for monitoring a position of an elevator car and/or counterweight, as known in the art. For example, it includes but is not limited to an encoder, a sensor, or other component, and may include speed sensing, absolute position sensing, and the like.

The controller 115 may be located in a controller room 118 of the elevator hoistway 117 and may be configured to control the operation of the elevator system 100, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference device 113 or any other desired device or system of this kind. When moving up or down within the elevator hoistway 117 along guide rail 109, the elevator car 103 may stop at one or more landings 119 as controlled by the controller 115. Although shown in a controller room 118, those skilled in the art will appreciate that the controller 115 can be located and/or configured in other locations or positions within the elevator system 100, such as located remotely or in the cloud.

Although specific elevators and components are shown and described herein, FIG. 1 is merely a non-limiting example presented for illustrative and explanatory purposes. It should be noted that other elevator systems and their cars can be configured to use the elevator car roof protection device disclosed herein, such as in environments where the roof space of the elevator hoistway is relatively small, for example, in home lifts and other occasions. For the sake of simplifying the drawing, identical or similar components and features may only be indicated in one or several locations within the same drawing. Technical terms such as “first”, “second”, “third”, etc. are only used for the purpose of distinguishing and are not intended to indicate the order and relative importance thereof. The technical term “connect” (or “engage”) means the realization of connection (or engagement) in a direct or an indirect manner.

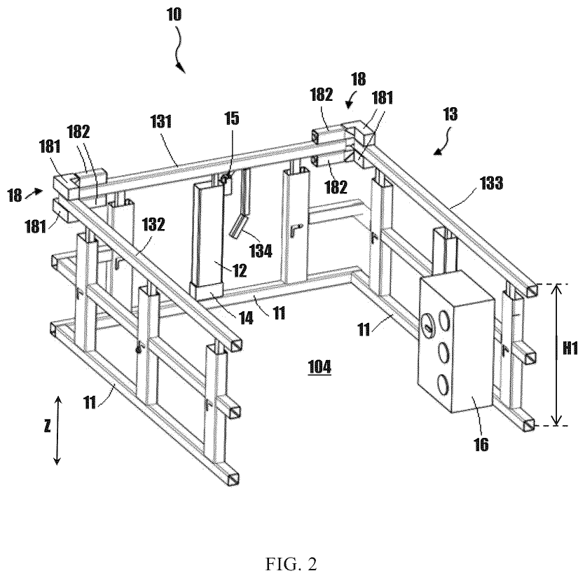

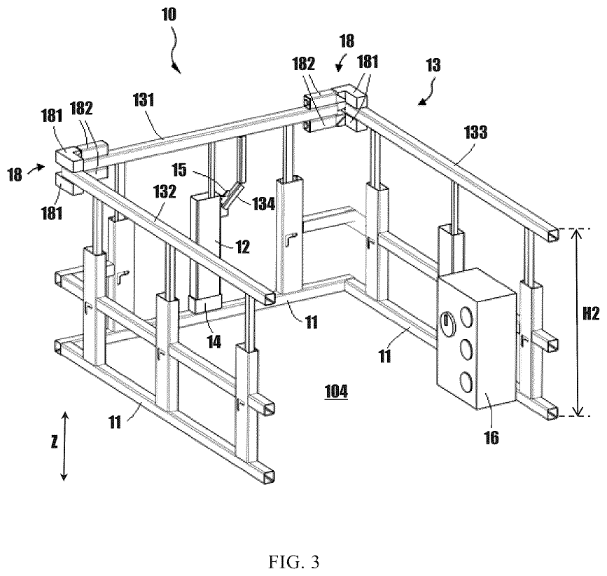

FIG. 2 schematically illustrates the general scenario of mounting an embodiment of an elevator car roof protection device on the roof of an elevator car. In the subsequent FIG. 3, the general scenario of the height of the guardrail being raised in this embodiment of the elevator car roof protection device is further illustrated. The examples in FIG. 2 and FIG. 3 may correspond to different states of the elevator system 100, such as a normal operation state and a maintenance state. According to one or more embodiments of the present disclosure, corresponding to the different states that the elevator system is currently in, it is possible to conveniently and efficiently control the guardrail to automatically reach corresponding different heights (specific height values can be set as needed), thereby facilitating practical application and improving system safety.

Specifically, as shown in FIGS. 2 and 3, the elevator car roof protection device 10 comprises a guardrail 13, which is used to define a protective area to ensure the safety of workers performing equipment debugging, maintenance, and other operations on the roof 104 of the elevator car 103, thereby preventing accidental falls of workers or equipment into the elevator hoistway. As used herein, in various embodiments, a base 11 may be mounted on the roof 104 of the elevator car 103, and the guardrail 13 may be mounted to the base 11 in a detachable manner. The base 11 may be constructed using one or more suitable materials and formed into any shape that meets application requirements. The base 11 may be fixed in place on the roof 104 by means of connectors such as bolts and screws, or by welding and other feasible methods. By way of example, the guardrail 13 may be connected to the base 11 through guide portions 12. The number of guide portions 12 may be configured according to the specific structure of the guardrail 13. For instance, in the illustrated elevator car roof protection device 10, nine guide portions 12 are optionally provided. The guide portions 12 may serve to better guide the up and down movements of the guardrail 13. The guide portions 12 may be mounted to the base 11, and one or more of the guide portions 12 may be selectively connected to a power portion 14 in the elevator car roof protection device 10. The power from the power portion 14 may then be transmitted to the guardrail 13 through these guide portions 12, thereby driving the guardrail 13 to move up and down in the vertical direction Z, for example, ascending or descending relative to the roof 104, thereby reaching a desired height after the height position of the guardrail 13 is changed. As schematically illustrated in FIGS. 2 and 3, the guardrail 13 can be raised from an initial height H1 shown in FIG. 2 to a relatively higher height H2. Further details will be provided subsequently.

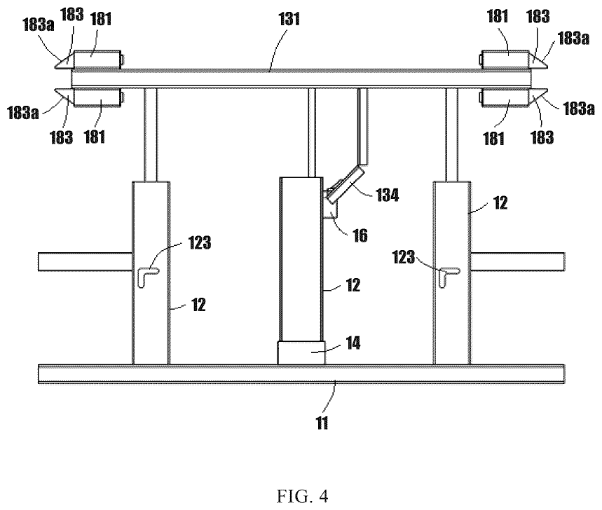

The guardrail 13 may adopt a frame structure, for example, using stainless steel pipes or the like. The guardrail 13 can be integrally formed, or constructed into two, three, or more parts that can be assembled together according to actual requirements. The specific configurations of these parts may be the same or different from each other. As used herein, the guardrail 13 may be configured to comprise a first guardrail 131, a second guardrail 132, and a third guardrail 133. The second guardrail 132 and third guardrail 133 may optionally be symmetrically arranged on both sides of the first guardrail 131. The overall structure of the guardrail 13 is formed by assembling the above three parts, thereby defining a protective area. The protective area typically has an entrance open toward the direction of the landing door to facilitate entry and exit by the workers. For the components of the guardrail 13, they may be detachably connected through connecting assemblies 18, as exemplarily shown in FIGS. 2 to 7. Thus, after the guardrail 13 are fully assembled, even if only one part of the guardrail 13 (e.g., the first guardrail 131 as shown in FIG. 4) receives the power output from the power portion 14, it can drive the other components of the guardrail 13 to move together.

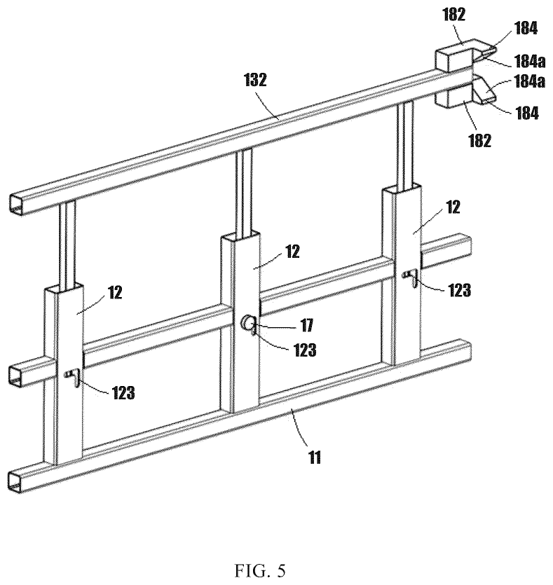

As an optional configuration, the connecting assembly 18 may comprise a first connecting member 181 and a second connecting member 182, which can be respectively mounted on two adjacent components of the guardrail 13. For example, as shown in FIGS. 4 and 5, a first connecting member 181 can be mounted at both ends of the first guardrail 131, so as to be assembled with a second connecting member 182 mounted at the corresponding end of the second guardrail 132 or the third guardrail 133. As used herein, in a plurality of embodiments, a pair of connecting assemblies 18 may optionally be mounted at the upper and lower positions of the corresponding ends of these components of the guardrail 13 to assemble them into a more stable and reliable structure, enabling these components of the guardrail 13 to better synchronize in ascending or descending movements under power drive.

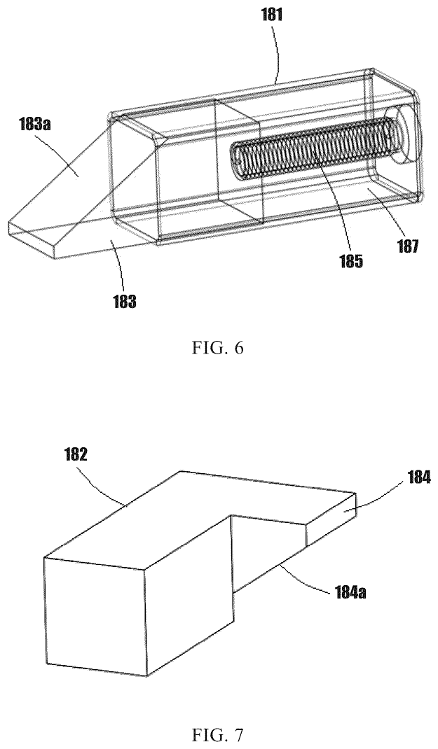

Referring to FIGS. 6 and 7, optionally, the first connecting member 181 may be provided with a first mating portion 183 and an operating portion 185, and the second connecting member 182 may be provided with a second mating portion 184. For example, the first mating portion 183 may optionally be configured as a slider, the operating portion 185 may optionally be configured as a spring, and the second mating portion 184 may optionally be configured as a protrusion. During assembly, the first mating portion 183 may be movably arranged within a receiving space 187 (e.g., a groove structure) of the first connecting member 181, allowing the first mating portion 183 to abut against the operating portion 185, so that the operating portion 185 can apply a force to the first mating portion 183 to move it toward the second mating portion 184. After the first connecting member 181 and the second connecting member 182 are mounted in place, the force applied by means of the operating portion 185 causes the first mating portion 183 to abut against and engage with the second mating portion 184, thereby enabling the adjacent components of the guardrail 13 to perform ascending or descending movements together after they have been assembled and connected. As another example, corresponding matching structures may be respectively provided on the first mating portion 183 and the second mating portion 184, such as the first inclined surface 183a and the second inclined surface 184a shown in FIGS. 6 and 7. These two inclined surfaces are adapted to each other, facilitating the formation of a relatively larger contact area and easier engagement and disengagement, thereby promoting better assembly and disassembly between the first connecting member 181 and the second connecting member 182, i.e., promoting better assembly and disassembly between two adjacent components of the guardrail 13.

By pre-setting and adjusting the magnitude of the force applied by the operating portion 185 to the first mating portion 183, the purpose of assembling and engaging adjacent connecting members or guardrail components as described above can be achieved. Additionally, by optionally pre-setting the magnitude of the above force, such as by selecting the configuration of the operating portion 185 (e.g., the material, quantity, and amount of compression of the spring selected when it is in the form of a spring), when the actual force between adjacent connected guardrail components exceeds the above force in certain situations, the first mating portion 183 and the second mating portion 184 can be disengaged, allowing the adjacent connected guardrail components to safely separate. This is particularly advantageous in situations where different powers are configured for different components of the guardrail, avoiding damage to the guardrail structure due to their inability to synchronize in ascending or descending movements.

In the elevator car roof protection device 10, the power portion 14 provides power to the guardrail 13, enabling the guardrail 13 to move up and down in the vertical direction Z. The power portion 14 can be configured as needed, for example, by configuring one or more devices or equipment that can provide mechanical force, hydraulic force, pneumatic force, and/or electromagnetic force, and the power portion 14 is arranged at a suitable position on the roof 104 of the elevator car 103.

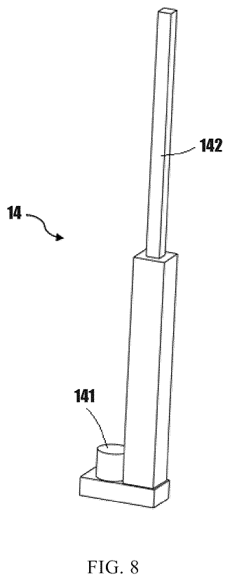

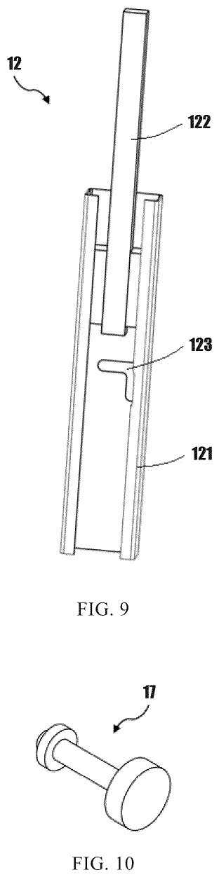

As an example, as used herein, the power portion 14 can be mounted on the base 11 and configured to have one or more electric devices 141 (e.g., in the form of electric cylinders or electric motors, etc.). The output end 142 (e.g., in the form of a lifting rod) of the power portion 14 outputs power externally. For example, as shown in FIG. 8 and in conjunction with FIG. 9, at least a part of the power portion 14 can optionally be arranged within the housing 121 of the guide portion 12, and the output end 142 thereof is drivably connected to one end of a movable component 122 in one of the guide portions 12. The other end of the movable component 122 is connected to the guardrail 13, for example, to the lower ends of the first guardrail 131, the second guardrail 132, and/or the third guardrail 133, thereby transmitting the power from the power portion 14 to the guardrail 13 to drive the guardrail 13 to move up and down. This allows the height position of the guardrail 13 to be changed as needed.

As used herein, in various embodiments, a detection member 15 can be provided in the elevator car roof protection device 10 to detect the movement position of the guardrail 13. For example, when the guardrail 13 reaches a preset height in the vertical direction Z, such as ascending to the height H2 (e.g., 1100 mm, etc.) as shown in FIG. 3 or returning to the height H1 (e.g., 900 mm, etc.) as shown in FIG. 2, the detection member 15 can generate a working signal (e.g., a current or voltage signal, etc.). The control portion (not shown) in the elevator car roof protection device 10 can receive the above working signal and then control the power portion 14 to stop outputting power.

The detection member 15 can be implemented using any components, including but not limited to limit switches, position sensors, infrared sensors, and the like. As exemplarily shown in FIGS. 2 and 3, a mating portion 134 (e.g., an extension or protrusion structure, such as a rod and the like) can be provided on the guardrail 13 (e.g., the first guardrail 131), and the detection member 15 can optionally be configured as a limit switch and to be mounted on the housing 121 of the guide portion 12. Thus, when the guardrail 13 rises or lowers to a preset height, the mating portion 134 will cause the detection member 15 to generate a working signal, for example, by triggering the detection member 15 by the mating portion 134 to generate the working signal. In one or some embodiments, the inherent structure on the guardrail 13 can also be directly used as the mating portion 134 to achieve all or part of its functions. For example, when the guardrail 13 descends from a previously higher height to a preset height, such as returning from the height H2 to the height H1 as an example, the lower surface of the guardrail 13 can be used to trigger the detection member 15 to generate a working signal, thereby controlling the power portion 14 to stop outputting power, causing the guardrail 13 to stop moving up and down when it reaches the above preset height.

In the elevator car roof protection device 10, the control portion is arranged on the roof 104 of the elevator car 103. The control portion is electrically connected to the power portion 14, and configured to control the operation of the power portion 14. The control portion can be implemented using any feasible components, units, or modules, such as control circuits, button switches, knob switches, and the like. In cases where the power portion 14 itself is configured with a control part, such as a motor with a controller, this control part can be used as part of the control portion in the elevator car roof protection device 10. For example, a box 16 can be mounted on the roof 104 of the elevator car 103, such as on the ground of the roof 104 or on the base 11 or any other suitable location, such as near the landing door position of the elevator system 100. Part or all of the control portion can be disposed in the box 16, for example, being arranged inside and/or on the outer surface of the box 16, so as to facilitate operation and control of the elevator car roof protection device 10 by the workers. It should be noted that other components of the elevator system 100 can be arranged in the box 16, such as control devices, power supply switches, etc. that can control the elevator system 100 to come into a maintenance state or normal operation state. Alternatively, the box 16 can directly utilize existing configurations such as maintenance boxes that the system may already have, without the need for additional configuration. According to actual application requirements, the control portion can be electrically connected to the above components of the elevator system to form associated operations, or it can operate independently without association.

During elevator maintenance operations, the workers can operate the control devices on the box 16 from outside the elevator hoistway 117 through the open landing door, causing the elevator system 100 to enter a maintenance state. At this point, the above control portion can be operated to control the guardrail 13 in the elevator car roof protection device 10 to automatically move up and down, for example, from the relatively low height H1 shown in FIG. 2 to the relatively high height H2, thereby providing better safety protection. This avoids the troublesome operations of existing guardrail requiring the workers to enter the car roof space and repeatedly and manually disassemble fasteners, and then mount the guardrail to increase height, especially preventing the unfavorable situation where the workers are prone to neglect and forget to raise the guardrail, which would lead to safety accidents.

After completing elevator maintenance and other operations, the workers can leave the car roof space and retreat to a safe position outside the landing door, and then operate the control devices on the box 16 from outside the elevator hoistway 117 to restore the elevator system 100 to the normal operation state. At this point, the above control portion can be operated to control the guardrail 13 in the elevator car roof protection device 10 to automatically move up and down, for example, returning from the relatively high height H2 shown in FIG. 3 to the initial relatively low

### Height H1.

Referring to FIGS. 4, 5, 9, and 10, as an optional configuration, a limiting portion 123 can be provided on the guide portion 12. For example, the limiting portion 123 can be configured into a suitable shape such as a hole or slot, so as to provide one or more limiting positions through such structures. One or more limiting members 17, such as latch pins, can be configured for the elevator car roof protection device 10. After the limiting member 17 is operably engaged with the limiting portion 120, the guardrail 13 can be fixed at the current height position to avoid displacement changes. For example, FIG. 5 exemplarily illustrates the specific situation where one limiting member 17 is used for the above limiting operation. As mentioned above, when the limiting portion 123 is configured to provide several limiting positions, the guardrail 13 can be conveniently selected to be fixed at different height positions as required by applications, such as the aforementioned height H1, height H2, or other heights, thereby enabling the guardrail 13 to more reliably remain at the desired height position, further ensuring system safety.

The solutions of the present disclosure can achieve automatic control of the ascent and descent of the guardrail, which greatly facilitates the actual use of the elevator system, eliminates potential safety hazards, avoids accidents, and optimizes the use configuration of the elevator car roof protection device as needed. For example, for application scenarios where the roof space of the elevator hoistway is relatively small, the initial height of the guardrail can be configured to be relatively low so as to occupy less space. When required, the power provided by the power portion can drive the guardrail to quickly and efficiently rise to an expected height position to provide reliable safety protection, which saves both time and labor.

An elevator car roof protection device, an elevator car, and an elevator system according to the present disclosure have been described above in detail by way of examples only. These examples are merely used to illustrate the principles and embodiments of the present disclosure, rather than limiting the present disclosure. Various modifications and improvements can be made by those skilled in the art without departing from the scope of the present disclosure. Therefore, all equivalent technical solutions should fall within the scope of the present disclosure and be defined by the claims of the present disclosure.

What is claimed is:

1. An elevator car roof protection device, comprising:
a guardrail arranged on a roof of an elevator car and defining a protective area, wherein the guardrail is configured to be movable in a vertical direction relative to the roof under power drive such that the guardrail is adjustable to have different heights corresponding to different states of an elevator system;
a power portion arranged on the roof and configured to provide the power to the guardrail; and
a control portion arranged on the roof, wherein the control portion is electrically connected to the power portion and configured to control operation of the power portion.

2. The elevator car roof protection device according to claim 1, wherein the guardrail is configured to have a first height relative to the roof when the elevator system is in a normal operation state, and have a second height relative to the roof when the elevator system is in a maintenance state, the second height being greater than the first height.

3. The elevator car roof protection device according to claim 1, wherein the guardrail comprise a first guardrail and a second guardrail adjacent to each other, the first guardrail being detachably connected to the second guardrail.

4. The elevator car roof protection device according to claim 3, wherein the first guardrail and the second guardrail are detachably connected through a connecting assembly, the connecting assembly comprising:
a first connecting member, mounted on one of the first guardrail and the second guardrail, and having a first mating portion and an operating portion; and
a second connecting member, disposed on the other of the first guardrail and the second guardrail, and having a second mating portion;
wherein the operating portion is configured to apply a preset force to the first mating portion to engage it with the second mating portion after the first connecting member and the second connecting member are mounted in place, such that the first guardrail and the second guardrail are detachably connected and move up and down together, and to make the first mating portion to disengage from the second mating portion when an acting force between the first guardrail and the second guardrail is greater than the preset force, such that the first guardrail is disconnected from the second guardrail.

5. The elevator car roof protection device according to claim 4, wherein the first connecting member has a receiving space, and the first mating portion is configured as a slider movably arranged within the receiving space and abutting against the operating portion, the slider being moved toward the second mating portion under the action of the preset force to engage with the second mating portion.

6. The elevator car roof protection device according to claim 5, wherein the slider has a first inclined surface, and the second mating portion has a second inclined surface matching the first inclined surface, the first inclined surface and the second inclined surface abutting against each other after the first connecting member and the second connecting member are mounted in place; and/or, the operating portion comprises a spring.

7. The elevator car roof protection device according to claim 1, wherein the guardrail comprises a first guardrail, a second guardrail and a third guardrail, the second guardrail and the third guardrail are respectively arranged on two sides of the first guardrail, and at least one of the second guardrail and the third guardrail is detachably connected to the first guardrail.

8. The elevator car roof protection device according to claim 1, wherein the elevator car roof protection device further comprises a base arranged on the roof, and guide portions mounted on the base and connected to the guardrail, at least one of guide portions being connected to the power portion and transmitting the power to the guardrail.

9. The elevator car roof protection device according to claim 8, wherein the guide portion has a limiting portion, and the elevator car roof protection device further comprises a limiting member configured to operably engage with the limiting portion such that the guardrail is fixed at a current height position.

10. The elevator car roof protection device according to claim 9, wherein the limiting portion is configured as a slot having one or more limiting positions, and the limiting member comprises a latch pin which, when engaged with the limiting portion at different limiting positions, causes the guardrail to be fixed at different height positions.

11. The elevator car roof protection device according to claim 1, wherein the elevator car roof protection device further comprises:
a detection member configured to generate a working signal that is transmitted to the control portion for control to stop the power portion from outputting the power when the guardrail reaches a preset height in the vertical direction; and/or
a box arranged on the roof, at least a part of the control portion being arranged in the box.

12. The elevator car roof protection device according to claim 11, wherein the detection member comprises a limit switch, and the guardrail is configured with a mating portion which triggers the limit switch to generate the working signal when the guardrail reaches the preset height.

13. The elevator car roof protection device according to claim 11, wherein the box is arranged in a position adjacent to a landing door of the elevator system.

14. The elevator car roof protection device according to claim 1, wherein the power portion comprises one or more electric devices, and the elevator car roof protection device comprises a base arranged on the roof, the electric device being mounted on the base and an output end of the electric device being connected to the guardrail.

15. An elevator car, wherein a roof of the elevator car is provided with an elevator car roof protection device according to claim 1.

16. An elevator system, comprising:
one or more elevator cars, configured to run within an elevator hoistway; and
an elevator car roof protection device according to claim 1, mounted on a roof of at least one of the elevator cars.
